(19) United States
(12) Patent Application Publication
(10) Pub. No.: US 2007/0126693 A1
(43) Pub. Date: Jun. 7, 2007

(54) Method and apparatus for reducing edge image retention in an electrophoretic display device

(76) Inventors: Mark Thomas Johnson, Eindhoven (NL); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/579,307

(22) PCT Filed: Nov. 17, 2004
(86) PCT No.: PCT/IB04/52459

§ 371 Date: May 16, 2006

(30) Foreign Application Priority Data
Nov. 21, 2003 (EP) 03104297.1

(51) Int. Cl. G09G 3/34

(52) U.S. Cl. 345/107

(57) ABSTRACT

The invention relates to an electrophoretic display device (1) comprising charged particles (8, 9) in a fluid (10) between a pair of electrodes (5, 6). A drive means is arranged and configured to supply a drive waveform to the electrodes (5, 6), the drive waveform comprising a sequence of drive signals for effecting respective optical transitions by causing the charged particles (8, 9) to occupy a predetermined position between the electrodes (5, 6) according to image data required to be displayed, and at least one voltage pulse, preferably prior to each drive signal, for inducing a substantially uniform electric field distribution across the display device (1). This has the effect of significantly reducing edge image retention and/or ghosting.

This invention relates to an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, and drive means arranged to supply a sequence of drive signals to said electrodes, each drive signal causing said particles to occupy a predetermined optical state corresponding to image information to be displayed.

An electrophoretic display comprises an electrophoretic medium consisting of charged particles in a fluid, a plurality of picture elements (pixels) arranged in a matrix, first and second electrodes associated with each pixel, and a voltage driver for applying a potential difference to the electrodes of each pixel to cause the charged particles to occupy a position between the electrodes, depending on the value and duration of the applied potential difference, so as to display a picture.

In more detail, an electrophoretic display device is a matrix display with a matrix of pixels which are associated with intersections of crossing data electrodes and select electrodes. A grey level, or level of colorization of a pixel, depends on the time a drive voltage of a particular level is present across the pixel. This is also referred to as the energy (=voltage×time) applied to the pixel. Dependent on the polarity of the drive voltage, the optical state of the pixel changes from its present optical state continuously towards one of the two limit situations (i.e. extreme optical states), e.g. one type of charged particles is near the top or near the bottom of the pixel. Intermediate optical states, e.g. greyscales in a black and white display, are obtained by controlling the time the voltage is present across the pixel.

Usually, all of the pixels are selected line-by-line by supplying appropriate voltages to the select electrodes. The data is supplied in parallel via the data electrodes to the pixels associated with the selected line. If the display is an active matrix display, the select electrodes are provided with, for example, TFT's, MIM,s, diodes, etc., which in turn allow data to be supplied to the pixel. The time required to select all of the pixels of the matrix display once is called the sub-frame period. In known arrangements, a particular pixel either receives a positive drive voltage, a negative drive voltage, or a zero drive voltage during the whole sub-frame period, depending on the change in optical state, i.e. the image transition, 5 required to be effected. In this case, a zero drive voltage is usually applied to a pixel if no image transition (i.e. no change in optical state) is required to be effected.

A known electrophoretic display device is described in international patent application WO 99/53373. This patent application discloses an electronic ink display comprising two substrates, one of which is transparent, and the other is provided with electrodes arranged in rows and columns. A crossing between a row and a column electrode is associated with a picture element. The picture element is coupled to the column electrode via a thin-film transistor (TFT), the gate of which is coupled to the row electrode. This arrangement of picture elements, TFT transistors and row and column electrodes together forms an active matrix. Furthermore, the picture element comprises a pixel electrode. A row driver selects a row of picture elements and the column driver supplies a data signal to the selected row of picture elements via the column electrodes and the TFT transistors. The data signal corresponds to the image to be displayed.

Furthermore, an electronic ink is provided between the pixel electrode and a common electrode provided on the transparent substrate. The electronic ink comprises multiple microcapsules of about 10 to 50 microns. Each microcapsule comprises positively charged white particles and negatively charged black particles suspended in a fluid. When a positive field is applied to the pixel electrode, the white particles move to the side of the microcapsule on which the transparent substrate is provided, such that they become visible to a viewer. Simultaneously, the black particles move to the opposite side of the microcapsule, such that they are hidden from the viewer. Similarly, by applying a negative field to the pixel electrode, the black particles move to the side of the microcapsule on which the transparent substrate is provided, such that they become visible/black to a viewer. Simultaneously, the white particles move to the opposite side of the microcapsule, such that they are hidden from the viewer. When the electric field is removed, the display device remains in substantially the acquired optical state, and exhibits a bi-stable character.

Grey scales (i.e. intermediate optical states) can be created in the display device by controlling the amount of particles that move to the counter electrode at the top of the microcapsules. For example, the energy of the positive or negative electric field, defined as the product of field strength and the time of application, controls the amount of particles moving to the top of the microcapsules.

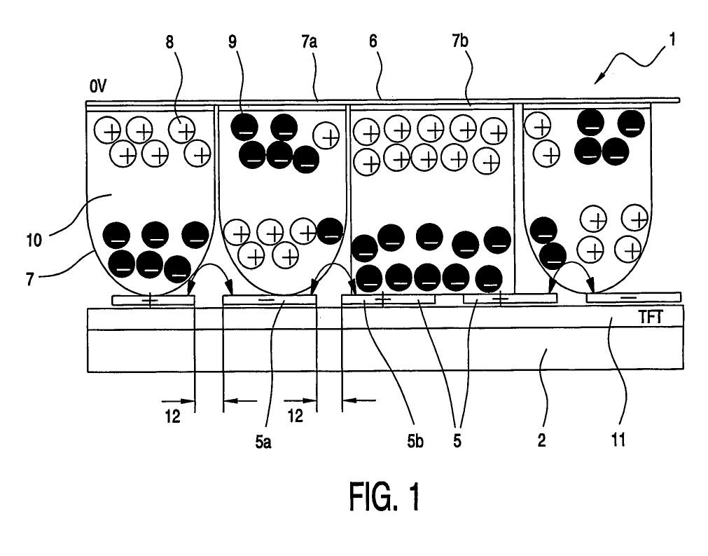

FIG. 1 of the drawings is a diagrammatic cross-section of a portion of an electrophoretic display device 1, for example, of the size of a few picture elements, comprising a base substrate 2, an electrophoretic film with an electronic ink which is present between a top transparent electrode 6 and multiple picture electrodes 5 coupled to the base substrate 2 via a TFT 11. The electronic ink comprises multiple microcapsules 7 of about 10 to 50 microns. Each microcapsule 7 comprises positively charged white particles 8 and negatively charged black particles 9 suspended in a fluid 10. When a positive field is applied to a picture electrode 5, the black particles 9 are drawn towards the electrode 5 and are hidden from the viewer, whereas the white particles 8 remain near the opposite electrode 6 and become visible white to a viewer. Conversely, if a negative field is applied to a picture electrode 5, the white particles are drawn towards the electrode 5 and are hidden from the viewer, whereas the black particles remain near the opposite electrode 6 and become visible black to a viewer. In theory, when the electric field is removed, the particles 8, 9 substantially remain in the acquired state and the display exhibits a bi-stable character and consumes substantially no power.

In order to increase the response speed of an electrophoretic display, it is desirable to increase the voltage difference across the electrophoretic particles. In displays based on electrophoretic particles in films, comprising either capsules (as described above) or micro-cups, additional layers, such as adhesive layers and binder layers are required for the construction. As these layers are also situated between the electrodes, they can cause voltage drops, and hence reduce the voltage, across the particles. Thus, it is possible to increase the conductivity of these layers so as to increase the response speed of the device.

Thus, the conductivity of such adhesive and binder layers should ideally be as high as possible, so as to ensure as low as possible a voltage drop in the layers and maximise the switching or response speed of the device. However, edge image retention/ghosting is often observed in active matrix electrophoretic displays, which becomes more severe as the conductivity of the adhesive layer is increased.

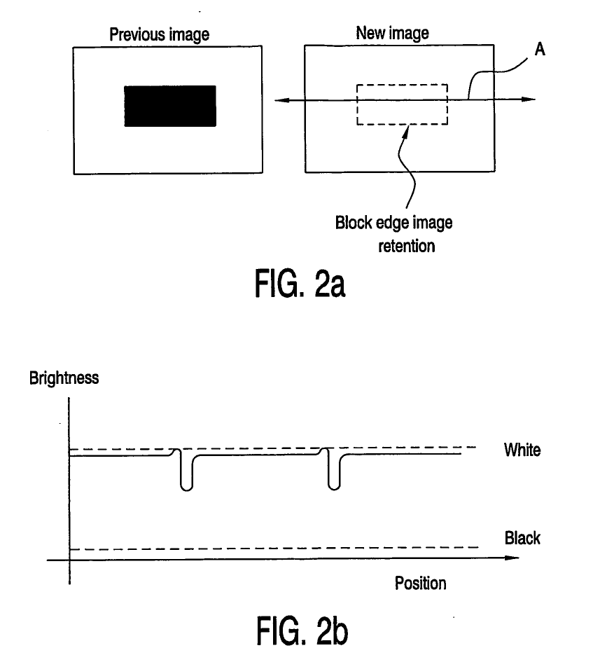

An example of edge ghosting is schematically illustrated in FIG. 2a of the drawings, in which the display is first updated with a simple black block on a white background, and then updated to a full white state. As shown, a dark outline corresponding to the edge of the original black block appears, i.e. at the position where the transition from black to white areas was previously present. A clear brightness drop is seen at or around these lines, as illustrated in FIG. 2b. This is because these areas have not received sufficient energy during an image update period, due to lateral crosstalk.

The term crosstalk refers to a phenomenon whereby the drive signal is not only applied to a selected pixel but also to other pixels around it, such that the display contrast is noticeably deteriorated. The manner in which this can occur is illustrated in FIG. 1. For example, consider the case where voltages of opposing polarity are applied to adjacent pixel electrodes 5, in the event that opposing optical states are intended to be effected in respective adjacent microcapsules, such as in the case of pixel electrodes 5a and 5 b, and respective microcapsules 7a and 7b. In the case of electrode 5a, a negative field is applied in order to draw the white charged particles 8 towards the electrode 5a and cause the black charged particles 9 to move toward the opposite electrode 6, and a positive field is applied to the electrode 5b in order to draw the black charged particles 9 towards the electrode 5b and cause the white charged particles 8 to move toward the opposite electrode 6. However, because the space 12 between the electrodes 5a and 5b is relatively small (by necessity, otherwise the resolution of the resultant image would be adversely affected), the field applied to the electrodes 5a and 5b may have an effect on the charged particles in the adjacent microcapsules 7b and 7a. As shown, therefore, even though a negative field is applied to the electrode 5a, it is partially cancelled by the positive field applied to electrode 5b, with the effect that a few black charged particles 9 close to the side of the microcapsule 7a nearest the adjacent pixel electrode 5b may not be supplied with sufficient energy for them to be pushed toward the electrode 6, and a few white charged particles may not be supplied with sufficient energy to be drawn toward the electrode 5a.

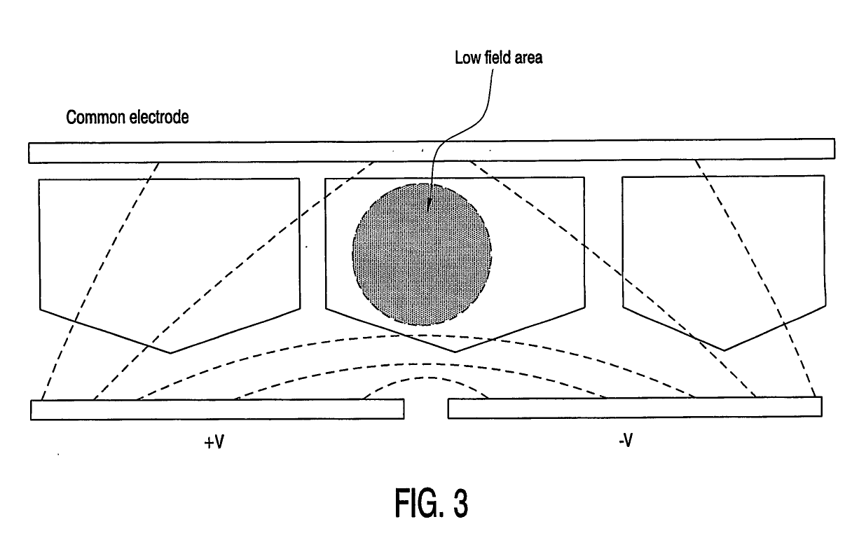

In summary, and as stated above, as the conductivity of the binder and adhesive layers is increased, so the problem of edge image retention becomes more severe. This is related to the higher conductivity of the layers, which results in only a small vertical electric field at a position between adjacent picture elements addressed with respective positive and negative voltages (i.e. at the boundary between the black and white picture elements (pixels) in FIG. 2a). This is illustrated in more detail in FIG. 3 of the drawings, in a case whereby a low resistance binder/adhesive layer is provided, and in which it can be seen that an area 13 having a low electrical field is created in a microcapsule 7b between pixels 7a, 7c of opposite polarity, because of lateral crosstalk, as described in detail above. Note that the dashed lines denote electric field lines.

Thus, the adverse effect of lateral crosstalk when it comes to the edge image retention illustrated in FIG. 2a, is particularly noticeable, and becomes worse, when a picture element is switched to black and the neighbouring pixels need to go to white. This is particularly visually disturbing because it is more visible than normal area image retention (i.e. in the case where an entire block is a little brighter or darker), and this is particularly unacceptable when the supposedly white area is required to remain at its nominal white state such that the respective pixels are not updated because of the bi-stable characteristic of the electrophoretic display.

Because of the bi-stable characteristics, the pixels without optical state change are usually not updated. However, the image stability is always relative and in practice the brightness the brightness will drift away from the initial value with an increased image holding time. A simple integration of such “ghosting” during next image updates is also unacceptable, in the sense that if the pixels were simply to be updated from white to white using a simple “top-up”, i.e a single voltage pulse of the appropriate polarity, the above-mentioned problem may be worsened and the greyscale accuracy is likely to be significantly reduced during subsequent transitions because the charged particles may stick to each other and/or to the electrode by multiple updates using a single polarity voltage, making it difficult to move them away when effecting the next desired image transition.

Thus, it is an object of the present invention to provide a method and apparatus for driving an electrophoretic display, with a further object of at least reducing block-edge image retention relative to prior art arrangements.

In accordance with the present invention, there is provided an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, and drive means arranged to supply a drive waveform to said electrodes, said drive waveform comprising: a) a sequence of drive signals, each effecting an image transition by causing said particles to occupy a predetermined optical state corresponding to image information to be displayed, and b) at least one voltage pulse in respect of each drive signal for inducing a substantially uniform electric field distribution across said display device.

The present invention also extends to a method of driving an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, the method comprising supplying a drive waveform to said electrodes, said drive waveform comprising: a) a sequence of drive signals, each effecting an image transition by causing said particles to occupy a predetermined optical state corresponding to image information to be displayed, and b) at least one voltage pulse in respect of each drive signal for inducing a substantially uniform electric field distribution across said display device.

The present invention extends further to apparatus for driving an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, the apparatus comprising drive means arranged to supply a drive waveform to said electrodes, said drive waveform comprising: a) a sequence of drive signals, each effecting an image transition by causing said particles to occupy a predetermined optical state corresponding to image information to be displayed, and b) at least one voltage pulse in respect of each drive signal for inducing a substantially uniform electric field distribution across said display.

The invention extends still further to a drive waveform for driving an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, the apparatus comprising drive means arranged to supply said drive signal to said electrodes, said drive waveform comprising: a) a sequence of drive signals, each effecting an image transition by causing said particles to occupy a predetermined optical state corresponding to image information to be displayed, and b) at least one voltage pulse in respect of each drive signal for inducing a substantially uniform electric field distribution across said display device.

The present invention offers significant advantages over prior art arrangements, including a significant reduction in serious edge image retention, by ensuring that the drive waveforms comprise a portion which induces a substantially uniform electric field distribution across the display, thereby ensuring that all of the particles in the display are subjected to a significant electric field at least during this portion of the waveform. This guarantees that the particles are regularly brought into motion which reduces the problems associated with particle sticking, an effect which becomes worse if the particles are not moved for a relatively long period of time (i.e. the so-called dwell time effect).

The at least one voltage pulse for inducing a substantially uniform electric field distribution across said display device is preferably provided in the waveform prior to, and more preferably substantially immediately prior to, a drive signal which is the data dependent portion of the drive waveform.

In one embodiment, said voltage pulse may comprise a single voltage pulse of a fixed polarity in respect of, and preferably prior to, each drive signal. In an alternative embodiment, multiple voltage pulses of a fixed polarity may be provided in respect of, and preferably prior to, each drive signal. In both cases, such voltage pulses may be of a relatively short duration (such as a present pulse) or of a longer duration, as required, and are preferably applied to the entire display (i.e. all of the picture elements), or a significant portion thereof, simultaneously.

In yet another embodiment of the invention, multiple voltage pulses of alternating polarity, either regularly or irregularly, may be provided in respect of, and preferably prior to, each drive signal. Again, in both cases, such voltage pulses may be of a relatively short duration (such as a present pulse) or of a longer duration, as required, and are again preferably applied to the entire display (i.e. all of the picture elements), or a significant portion thereof, simultaneously.

As stated above the one or more voltage pulses for inducing a substantially uniform electric field distribution across the entire display are preferably applied at an initial portion of each image update signal, i.e. prior to the drive signal for effecting an image transition. This is because the voltage pulse(s) are considered to be most effective if applied at this point in the drive waveform. However, in alternative embodiments, the at least one voltage pulse for inducing a substantially uniform electric field distribution across the entire display may be applied at any point between the completion of one image update and the start of another, or indeed may be embedded in an image update waveform.

The at least one voltage pulse may be applied in the normal line-at-a-time addressing manner, or in a “hardware driving” manner, whereby more than one line of picture elements are addressed substantially simultaneously. It is considered that the most effective way to apply the at least one voltage pulse is to ensure that the entire display (or at least a significant portion thereof) is addressed simultaneously, because this gives the most uniform electric field distribution, although this is not essential. By addressing the display quickly and then using a long hold period (“frame delay”), the effectiveness of the pulses is further increased.

These and other aspects of the present invention will be apparent from, and elucidated with reference to, the embodiments described herein.

Embodiments of the present invention will now be described by way of examples only and with reference to the accompanying drawings, in which:

FIG. 1 is a schematic cross-sectional view of a portion of an electrophoretic display device;

FIG. 2a is a schematic illustration of block image retention in an electrophoretic display panel;

FIG. 2b is a brightness profile taken along the arrow A in FIG. 2a;

FIG. 3 is a schematic cross-sectional view of a portion of an electrophoretic display device, showing field lines between picture elements of opposite polarity;

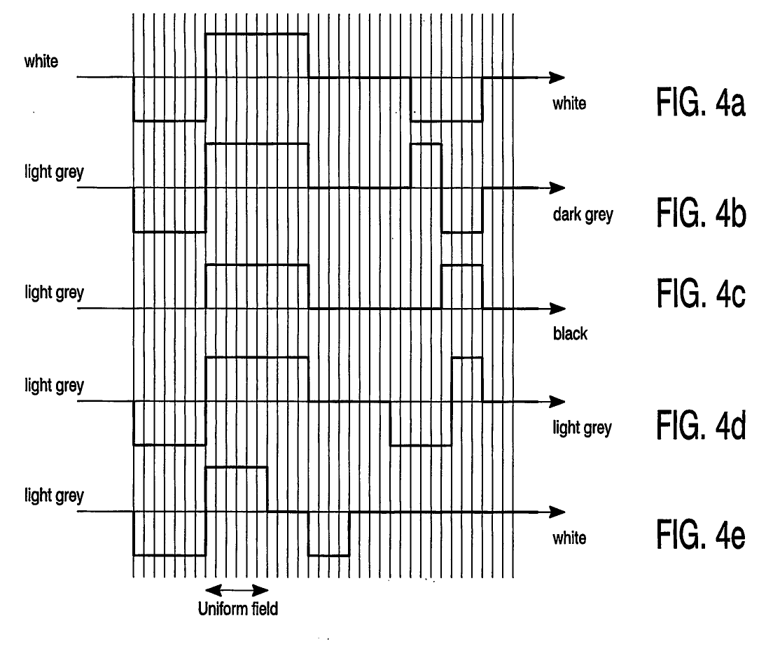

FIGS. 4a-4e illustrate drive waveforms for an electrophoretic display according to a first exemplary embodiment of the present invention;

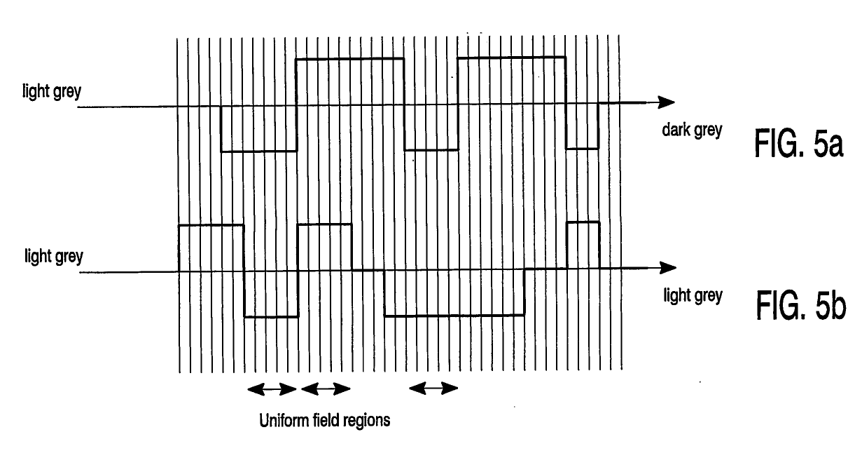

FIGS. 5a and 5b illustrate drive waveforms for an electrophoretic display according to a second exemplary embodiment of the present invention;

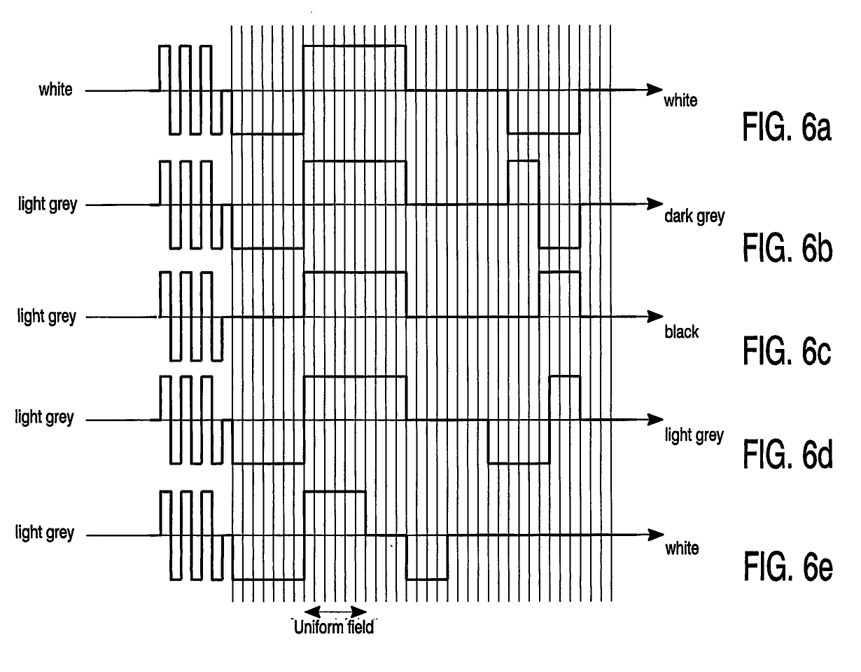

FIGS. 6a-6e illustrate drive waveforms for an electrophoretic display according to a third exemplary embodiment of the present invention; and

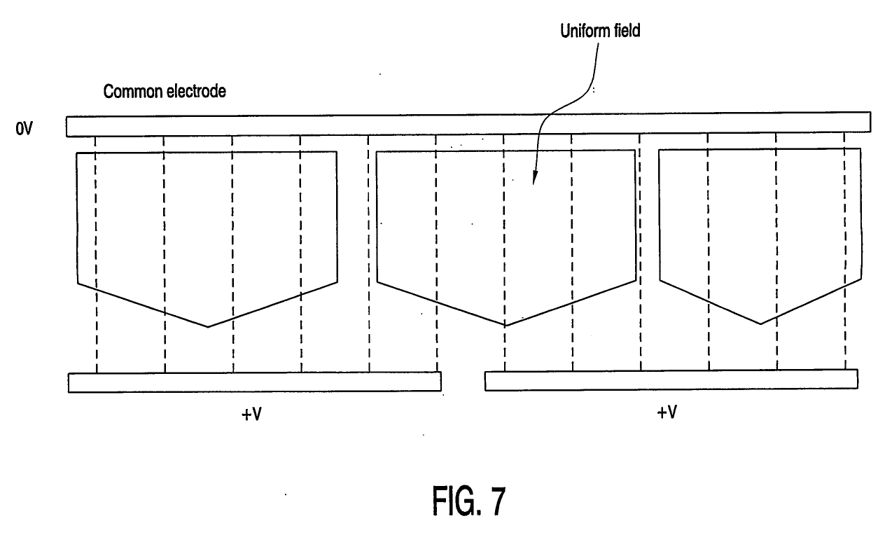

FIG. 7 is a schematic cross-sectional view of a portion of an electrophoretic display device according to an exemplary embodiment of the present invention, showing a uniform field distribution.

Thus, the present invention is intended to provide a method and apparatus for driving an electrophoretic display, with the object of at least reducing block-edge image retention relative to prior art arrangements. The invention is realised by the provision in the drive waveform of at least one voltage pulse in respect of each drive signal for inducing a substantially uniform electric field distribution across said display device.

As explained above, the present invention offers significant advantages over prior art arrangements, including a significant reduction in serious edge image retention, by ensuring that the drive waveforms comprise a portion which induces a substantially uniform electric field distribution across the display, thereby ensuring that all of the particles in the display are subjected to a significant electric field at least during this portion of the waveform. This guarantees that the particles are regularly brought into motion which reduces the problems associated with particle sticking, an effect which becomes worse if the particles are not moved for a relatively long period of time (i.e. the so-called dwell time effect)

Consider the case of an electrophoretic display device as described above, having two extreme optical states, i.e. white and black, and, say intermediate optical states wherein the charged particles are in respective intermediate positions between the two electrodes so as to give the picture element respective appearances intermediate the two extreme optical states, e.g. light grey and dark grey. In this example, the arrangement of pixel electrodes is such that when applying a negative voltage to the pixel electrode the pixel becomes more white, whilst when applying a positive voltage to the pixel electrode the pixel becomes more black.

FIG. 4a to 4e illustrate representative drive waveforms in respect of a first exemplary embodiment of the present invention, for image transitions white-white, light grey-dark grey, light grey-black, light grey-light grey, and light grey-white respectively. Referring to FIG. 4a of the drawings, in order to effect the image transition white-white, a negative drive signal is applied to the pixel electrodes, followed substantially immediately by a single voltage pulse of positive polarity, the first portion of which, in combination with the positive polarity drive voltages applied simultaneously to all pixels in the display, induces a uniform electric field distribution across the pixel and then, after a predetermined dwell time, another negative drive signal is applied which causes the pixel to return to its white state. Referring to FIG. 4b of the drawings, in the case of the light grey-dark grey image transition, a negative drive signal is applied to the pixel electrodes, followed substantially immediately by a single voltage pulse of positive polarity, which again induces a substantially uniform electric field distribution across the pixels in the display, and then, after a predetermined dwell time, a drive signal consisting of a positive voltage pulse immediately followed by a negative voltage pulse is applied, in order to effect the required image transition.

Referring to FIG. 4c, in the case of the light grey-black image transition, a single voltage pulse of positive polarity is applied to the pixel electrodes, in order to induce the substantially uniform electric field distribution across the pixels and then, after a predetermined dwell time, a drive signal comprising a single positive voltage pulse is applied in order to effect the desired image transition. The drive waveform for effecting the light grey-light grey image transition, as shown in FIG. 4d, is similar in many respects to that for the light grey-dark grey image transition illustrated in FIG. 4b, except that the final drive signal for effecting the desired image transition consists of a negative voltage pulse immediately followed by a positive voltage pulse. Finally, referring to FIG. 4e of the drawings, the drive waveform for effecting the light grey-white image transition comprises a negative drive signal, immediately followed by a positive voltage pulse for inducing the substantially uniform electric field distribution across the pixel, and then after a predetermined dwell time, a negative voltage pulse is applied to effect the desired image transition.

Thus, FIGS. 4a to 4e illustrate drive waveforms in respect of a first exemplary embodiment of the present invention, in which a single voltage pulse of a fixed polarity (in this case, positive) is employed to induce a substantially uniform electric field across each pixel. The advantage of this embodiment is its simple implementation relative to the significant reduction in edge image retention. It will be apparent that not all of these pulses start and finish at the same point in the drive waveforms—they simply have common portions where the polarity is the same. It will also be appreciated that FIGS. 4a to 4e only illustrate 5 of the possible 16 waveforms which would exist in the case of a display device having four optical states. All of the other waveforms will also comprise at least a voltage pulse with positive polarity at the same point of time during the waveform. In another exemplary embodiment of the present invention, multiple voltage pulses of a fixed polarity may be employed to induce the required uniform electric field distribution across the display.

As stated above, in another exemplary embodiment of the present invention, multiple pulses of a regularly or irregularly cnanging polarity may be employed to induce the required uniform electric field distribution across the display. Referring to FIGS. 5a and 5b, two of a possible 16 drive waveforms (in the case of the device having 4 optical states) are illustrated, whereby multiple voltage pulses of a changing polarity are employed. In the case of the light grey-dark grey image transition (FIG. 5a), a negative pulse immediately followed by a positive voltage pulse immediately followed by another negative voltage pulse induces the uniform electric field distribution, and then a negative voltage pulse is applied to effect the desired image transition. In the case of the light grey-light grey image transition (FIG. 5b), a positive drive signal is applied, followed by a negative and then a positive voltage pulse to induce the uniform electric field distribution, followed (after a short dwell time) by a relatively long negative voltage pulse, which includes a portion for inducing the uniform electric field distribution, and finally (after a short dwell time) a positive drive signal is applied to effect the desired image transition. Again, all of the other waveforms will also comprise at least the above mentioned 3 voltage pulses with changing polarity at the same point of time during the waveform. An advantage of this particular embodiment is that, although its specific implementation is a little more complex than that of FIGS. 4a- 4e, it is even more powerful in respect of reducing image retention.

FIGS. 6a to 6e illustrate drive waveforms which are substantially identical to those illustrated by FIGS. 5a to 5e respectively, except in this case, a series of shaking pulses are applied at the beginning of each drive waveform. It will be appreciated that a shaking pulse may be defined as a single polarity voltage pulse representing an energy value sufficient to release particles at any one of the optical state positions, but insufficient to move the particles from a current position to another position between the two electrodes. In other words, the energy value of the one or more shaking pulse is preferably insufficient to significantly change the optical state of a picture element. It will be further appreciated that such shaking pulses need not be included in all of the drive waveforms, but if they are, then they will also induce a substantially uniform electric field distribution across the pixel. In addition to the advantages mentioned above with respect to the embodiment of FIGS. 4a-4e, this embodiment has the further advantage of significantly reducing the effects of dwell time and image history. Additional sets of shaking pulses my be inserted at any place in the drive waveform for further optimising the display performance. The shaking pulses are preferably aligned in time in all drive waveforms so that they can be supplied simultaneously on all pixels, resulting in a more efficient update and better image quality.

For all of the above-described embodiments, a uniform electric field distribution between adjacent pixels is illustrated by FIG. 7 of the drawings. Note that, once again, the dashed lines denote electric field lines.

Note that the invention may be implemented in passive matrix as well as active matrix electrophoretic displays. The drive waveform can be pulse width modulated, voltage modulated, or a combination of the two. Also, the invention is applicable to both single and multiple window displays, where, for example, a typewriter mode exists. This invention is also applicable to colour bi-stable displays. Also, the electrode structure is not limited. For example, a top/bottom electrode structure, honeycomb structure, in-plane switching structure or other combined in-plane-switching and vertical switching may be used.

Embodiments of the present invention have been described above by way of example only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. An electrophoretic display device (1) comprising an electrophoretic material comprising charged particles (8, 9) in a fluid (10), a plurality of picture elements, first and second electrodes (5, 6) associated with each picture element, the charged particles (8, 9) being able to occupy a position being one of a plurality of positions between said electrodes (5, 6), said positions corresponding to respective optical states of said display device (1), and drive means arranged to supply a drive waveform to said electrodes (5, 6,) said drive waveform comprising:
a) a sequence of drive signals, each effecting an image transition by causing said particles (8, 9) to occupy a predetermined optical state corresponding to image information to be displayed, and b) at least one voltage pulse in respect of each drive signal for inducing a substantially uniform electric field distribution across said display device (1).

2. A display device (1) according to claim 1, wherein said at least one voltage pulse for inducing a substantially uniform electric field distribution across said display device (1) is provided in said drive waveform prior to each drive signal.

3. A display device (1) according to claim 2, wherein said at least one voltage pulse for inducing a substantially uniform electric field distribution across said display device (1) is provided in said drive waveform immediately prior to each drive signal.

4. A display device (1) according to claim 1, wherein said at least one voltage pulse comprises a single voltage pulse of a fixed polarity in respect of each drive signal.

5. A display device (1) according to claim 1, wherein multiple voltage pulses of a fixed polarity are provided in respect of each drive signal for inducing a substantially uniform electric field distribution across said display (1).

6. A display device (1) according to claim 1, wherein said at least one voltage pulse is applied to all of said picture elements, or at least a significant proportion thereof, simultaneously.

7. A display device (1) according to claim 1, multiple voltage pulses of alternating polarity are provided in respect of each drive signal for inducing a substantially uniform electric field distribution across said display (1).

8. A display device (1) according to claim 7, wherein said multiple voltage pulses are of substantially regularly alternating polarity.

9. A display device (1) according to claim 7, wherein said multiple voltage pulses are of irregularly alternating polarity.

10. A display device (1) according to claim 1, wherein said drive waveform is pulse width modulated.

11. A display device (1) according to claim 1, wherein said drive waveform is voltage modulated.

12. A display device (1) according to claim 1, wherein at least one individual drive waveform is substantially dc-balanced.

13. A display device according to claim 1, wherein at least some of the sub-sets of closed loops wherein an image transition cycle causes a pixel to have substantially the same optical state at the end of said cycle as at the beginning, are subsatantially dc-balanced.

14. A display device (1) according to claim 1, comprising two substrates (2), at least one of which is substantially transparent, whereby the charged particles (8, 9) are present between the two substrates (2).

15. A display device (1) according to claim 1, wherein the charged particles (8, 9) and the fluid (10) are encapsulated.

16. A display device (1) according to claim 15, wherein the charged particles (8, 9) and the fluid (10) are encapsulated in a plurality of individual microcapsules (7), each defining a respective picture element.

17. A display device (1) according to claim 1, having at least three optical states.

18. A display device (1) according to claim 1, wherein image transitions are effected in respect of one or more picture elements which do not substantially require an optical state change.

19. A display device (1) according to claim 18, wherein image transitions are effected in respect of all picture elements which do not substantially require an optical state change.

20. A method of driving an electrophoretic display device (1) comprising an electrophoretic material comprising charged particles (8, 9) in a fluid (10), a plurality of picture elements, first and second electrodes (5, 6) associated with each picture element, the charged particles (8, 9) being able to occupy a position being one of a plurality of positions between said electrodes (5, 6), said positions corresponding to respective optical states of said display device(1), the method comprising supplying a drive waveform to said electrodes (5, 6), said drive waveform comprising: a) a sequence of drive signals, each effecting an image transition by causing said particles (8, 9) to occupy a predetermined optical state corresponding to image information to be displayed, and b) at least one voltage pulse in respect of each drive signal for inducing a substantially uniform electric field distribution across said display device (1).

21. Apparatus for driving an electrophoretic display device (1) comprising an electrophoretic material comprising charged particles (8, 9) in a fluid (10), a plurality of picture elements, first and second electrodes (5, 6) associated with each picture element, the charged particles (8, 9) being able to occupy a position being one of a plurality of positions between said electrodes (5, 6), said positions corresponding to respective optical states of said display device (1), the apparatus comprising drive means arranged to supply a drive waveform to said electrodes (5, 6), said drive waveform comprising: a) a sequence of drive signals, each effecting an image transition by causing said particles (8, 9) to occupy a predetermined optical state corresponding to image information to be displayed, and b) at least one voltage pulse in respect of each drive signal for inducing a substantially uniform electric field distribution across said display (1).

22. A drive waveform for driving an electrophoretic display device (1) comprising an electrophoretic material comprising charged particles (8, 9) in a fluid (10), a plurality of picture elements, first and second electrodes (5, 6) associated with each picture element, the charged particles (8, 9) being able said electrodes (5, 6), said positions corresponding to respective optical states of said display device (1), the apparatus comprising drive means arranged to supply said drive signal to said electrodes (5, 6), said drive waveform comprising: a) a sequence of drive signals, each effecting an image transition by causing said particles (8, 9) to occupy a predetermined optical state corresponding to image information to be displayed, and b) at least one voltage pulse in respect of each drive signal for inducing a substantially uniform electric field distribution across said display device (1).
